(19) United States
(12) Patent Application Publication
(10) Pub. No.: US 2005/0186417 A1
(43) Pub. Date: Aug. 25, 2005

(54) Self-adhering paper strapping band

(76) Inventor: Peter A. Rodriguez, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 10/786,729

(22) Filed: Feb. 25, 2004

(51) Int. Cl. B32B 7/12

(52) U.S. Cl. 428/343; 428/354

(57) ABSTRACT

An improved bale strapping band and system and method for utilizing the same. The bale strapping band includes one or more folded paper strips, with multiple folds and plies resting on one another, normally glued or bonded together and treated on either or both of its external surfaces with water soluble adhesive, for use primarily in wood pulp bale strapping applications. The bale strapping band includes one or more mutually aligned and bonded paper strips having multiple longitudinal plies including a first external ply and an opposing second external ply, and at least one internal ply disposed between the first and second external plies. An external adhesive layer is disposed on the outer surface of the external plies to provide structural rigidity and abrasion resistance to the band, as well as to provide adhesive to join ends of the band together.

### BACKGROUND OF THE INVENTION

1. Technical Field

The present invention relates generally to bale packaging of material using straps or bands, and in particular to bale strapping systems and methods for banding bales of wood pulp or similar materials. More particularly, the present invention relates to a bale strapping band and a system and method for utilizing the same, wherein the band is self-adhering and is composed of a repulpable, recyclable and biodegradable material.

2. Description of the Related Art

In the course of manufacturing and distributing paper pulp, the pulp is packaged in bales of stacked, cut sheets. In accordance with traditional methods, the stacked sheets are compressed and wrapped in larger sheets of paper and usually tied with wire or plastic banding. The bales are then stored in large stacks and held in a warehouse for subsequent distribution.

When the end user receives banded bales and prepares them for processing, the metal or plastic bands must be removed so that the non-pulpable metal or plastic banding material does not contaminate, disrupt or damage the various wood pulp bale processing systems such as hydro-pulping systems. Removal of the baling bands imposes an additional step in pulp bale processing that consumes considerable time and effort and results in considerable end-waste that must be disposed of in some manner. Furthermore, improperly removed baling wire or remnant debris thereof may result in fouling or damage to expensive wood pulp processing machinery. Metallic wire banding additionally poses safety problems relating to manually handling and removing the wire. The band straps are wrapped under considerable tension around the bales and therefore expose the individual removing the wire to puncture or cut injuries when the banding wire rebounds or whips. The additional steps required to carefully and completely remove and dispose of metal or plastic bale banding substantially increases equipment and maintenance costs in addition to increasing the operating hazards of banding equipment.

To reduce the costs and improve the efficiency of the banding and band removal processes, bale bands constructed of biodegradable, repulpable materials such as paper have become popular as a replacement to metal or plastic bands. One such repulpable bale strapping band is made from twisted paper yarns that are glued together with a water-soluble adhesive that covers the entire surface of the yarns. The yarns are normally glued side by side and after the glue has dried, the band is wound onto a coil for packing, distribution and use.

While eliminating many of the problems associated with metallic or plastic bands relating to waste and safety, the twisted yarn band has a number of disadvantages. First, the individual yarns are susceptible to coming loose under the influence of heat and/or moisture thus compromising the band's structural integrity. More importantly, the individually produced yarns will often vary in diameter, resulting in excess friction and possible binding as the band is fed through the close tolerance feed channel of the bale strapping feed channel.

Folded or wrapped paper bands or strips are well known for many different uses, such as decorative applications, as straps or handles for bags or other containers, and as tear strips in paper mill operations. U.S. Pat. No. 5,816,526 to Bartelmuss et al. shows a multiple ply, folded paper tear strip for severing moving paper webs. Such tear strips act as cutting means to slice the paper web. As such, in this usage it is critical that the adhesive used to bond the plies be only internally applied, such that no adhesive is externally exposed to cause possible sticking problems (see e.g., col. 2, lines 53-54 and col. 3, lines 5-10). Such a construction would not function in the application at hand, given that it is necessary for the paper band to have an exterior adhesive in order to bond the ends of the band together.

An alternative approach to banding pulp bales with soluble strap members is shown in U.S. Pat. No. 5,066,363 to Lee et al., which teaches a strap made of polyvinyl alcohol in a rope or yarn configuration. Such a strap, however, lacks the rigidity required for feeding the strap through baling equipment, and thus is not a viable solution to the problems set forth above.

From the foregoing it can be appreciated that a need exists for an improved bale strapping band, and system and method for implementing the same, that reduces or eliminates the additional step of removing strap bands from the bales and other problems associated with metallic and plastic bale banding, and also eliminates the problems associated with twisted yarn strapping bands. The present invention addresses such a need.

### SUMMARY OF THE INVENTION

An improved bale strapping band and system and method for utilizing the same are disclosed herein. The bale strapping band includes one or more folded paper strips, with multiple folds and plies resting on one another, the strips and plies being glued or bonded together and treated on either or both of its exterior surfaces with a water soluble adhesive, for use in wood pulp bale strapping or similar applications. The bale strapping band is self-adhering, such that end portions of the band can be joined together utilizing heat and moisture without the need for the application of extra adhesives during the joining process. The bale strapping band includes one or more mutually aligned and bonded paper strips having multiple longitudinal plies including a first external ply and an opposing second external ply, and at least one internal ply disposed between the first and second external plies, with the plies being adhesively bonded to provide structural rigidity and strength. An external adhesive layer, preferably composed of a water soluble adhesive, is disposed on and within the outer surface of one or preferably both of the external plies to provide the means for joining ends of the band together in the bale strapping operation, wherein the external adhesive layer is of a type that can be reactivated by application of water, heat or both. In addition, the external adhesive layer and in particular the composite structure formed by the absorbed adhesive, internal and external plies increases the overall structural rigidity, tensile strength, resistance to separation and resistance to tear of the paper band.

The above as well as additional objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, firther objects and advantages thereof, will best be understood by reference to the following detailed description of an illustrative embodiment when read in conjunction with the accompanying drawings, wherein:

FIG. 1 depicts a four-ply bale strapping band in accordance with a first embodiment of the present invention;

FIG. 2 illustrates a six-ply bale strapping band in accordance with a second embodiment of the present invention;

FIG. 3 depicts a three-ply bale strapping band in accordance with a third embodiment of the present invention;

FIG. 4 illustrates a corrugated three-ply bale strapping band in accordance with a fourth embodiment of the present invention; and

FIG. 5 depicts an internally corrugated three-ply bale strapping band in accordance with a fifth embodiment of the present invention.

### DETAILED DESCRIPTION OF A PREFERRED EMBODIMENT

This invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

The present invention is directed to an improved system, method and apparatus for binding pulp or paper material into bales, as well as to a novel repulpable bale strapping band that may be advantageously employed in a pulp bale binding process. The system, method, apparatus and band are applicable to other circumstances where use of a repulpable, recyclable and biodegradable paper band is desirable. In a preferred embodiment, the improve bale strapping band includes one or more folded paper strips, with multiple folds and plies resting on one another, with the plies being glued or bonded together. The exterior of the band is treated with a water-soluble adhesive such that the exterior adhesive may be reactivated to join ends of the band together to form an encircling strap for a bale. In addition, the external adhesive layer, and in particular the composite structure formed by the absorbed adhesive and the external plies, increases the overall structural rigidity, tensile strength, resistance to separation and resistance to tear of the paper band. The band can be shaped in a variety of band geometries and can be designed to achieve varying tensile strengths in accordance with the tensile strength of the constituent paper and adhesive materials, and by varying the number of paper plies or folds. A preferably water-soluble adhesive is applied both to the exterior plies and between the interior plies of the bale strapping band to achieve a structural rigidity and capacity of the band to maintain the finished dimensions, as the water-soluble adhesive will wick into or be absorbed by the paper plies to create an adhesive layer both on the surface of the plies as well as interspersed within the plies.

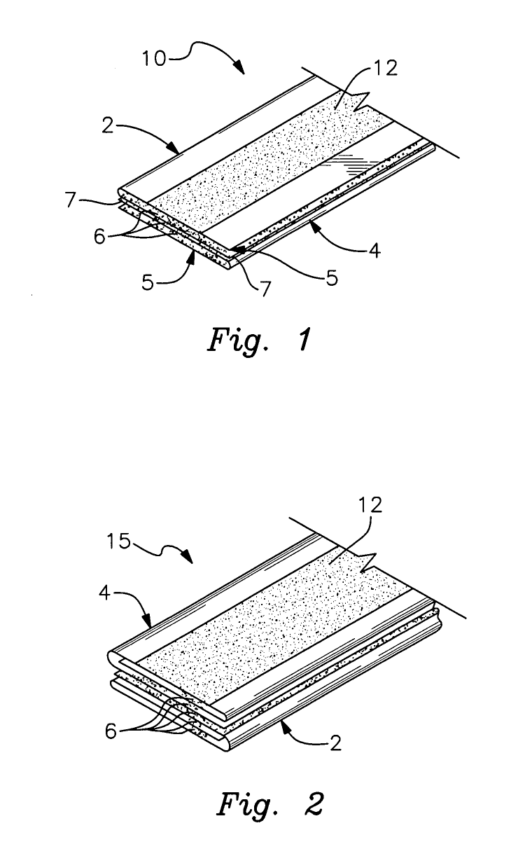

With reference now to the figures, wherein like reference numerals refer to like and corresponding parts throughout, and in particular with reference to FIG. 1, there is depicted a four-ply bale strapping band 10 in accordance with a first embodiment of the present invention. In accordance with the depicted embodiment, bale strapping band 10 is a composite assembly comprising a pair of paper strips 2 and 4. As shown in the perspective view depicted in FIG. 1, each of paper strips 2 and 4 are longitudinally folded into two plies, resulting in bale strapping band 10 having a total of four plies when strips 2 and 4 are mutually adhered by one or more internal adhesive layers 6. Internal adhesive layers 6, preferably constituting a moisture and/or heat activated glue or bonding material, may be applied as a coating, layer or film between the inner plies 7 and outer plies 5 of each of paper strips 2 and 4. Most preferably, the internal adhesive layers 6 are composed of a water-soluble adhesive, such that the adhesive when applied in liquid form to the plies will wick or soak into and below the surface of the plies to create a stronger bond when dried. The paper and glue composite band 10, with the adhesive in the dry or non-activated state, has excellent structural integrity during passage through the strapping equipment, yet the adhesive may be readily re-activated as required in the area where the band 10 is to be bonded to itself.

In accordance with an important feature of the present invention, paper strips 2 and 4 are comprised of a synthetic or preferably natural plant fiber material that is biodegradable and may be repulped with the bale wood pulp material, thus eliminating the need to remove bale strapping band 10 prior to repulping or re-dissolving and processing the object bale. In this manner, the use of plant fiber based strips 2 and 4 eliminates the time consuming and costly additional pulp bale processing steps required for removing bale banding and furthermore eliminates the waste and potential hazards associated with bale banding removal.

The selection of a specific repulpable and biodegradable material or combination of repulpable materials for paper strips 2 and 4 is preferably determined in accordance with the structural characteristics and anticipated processing and handling logistics for the object pulp bale. Furthermore, paper strips 2 and 4 are preferably fabricated such that the elongate cell walls and lumens (not depicted) of the constituent plant fiber material are arranged in substantial longitudinal (i.e. lengthwise) alignment along paper strips 2 and 4 for improved tensile strength characteristics. Likewise, the relative structural dimensions of bale strapping band 10, such as its slenderness ratio (i.e. width divided by thickness), are preferably set in accordance with load and handling requirements.

The one or more internal adhesive layers 6 preferably constitute a water-soluble adhesive or bonding material having suitable strength and rigidity characteristics such that, in addition to providing inter-ply bonding, the adhesive layers 6 impart significant backbone rigidity and tensile strength enhancement to bale strapping band 10. Such adhesives are known in the art.

Conventional bale bands utilize materials such as high tensile strength metals and plastics to meet the strenuous loading and bale handling performance requirements required to securely bind bales typically weighing between 500 and 600 lbs. To emulate the load handling and binding performance characteristics of conventional bale strapping bands made of metals or plastics, and as further illustrated in FIG. 1, the composite four-ply bale strapping band 10 further includes an external adhesive layer 12 applied as a continuous adhesive layer over the exterior surface of one or preferably both of the outer plies 5. External adhesive layer 12 is preferably water-soluble and constitutes a moisture and/or heat activated glue or bonding material that may be applied as a coating, layer, or film on the outer surface of bale strapping band 10 that serves the additional function of being the adhesive used to secure two ends of the paper band 10.

In addition to increasing the rigidity and tensile strength of composite bale strapping band 10, external adhesive layer 12 is substantially more tear-resistant than the underlying paper strips 2 and 4 and thus protects the paper strips from damage resulting from friction or other mechanical forces applied from the relatively rigid bale bundle surfaces, particularly at the squared edges that otherwise would be prone to cut, through a paper bale band. This tear resistance effect is greatly magnified by the natural tendency of the water-soluble external adhesive layer to wick into the porous fiber of outer layers 5, thus forming a relatively continuous paper and glue composite of significant thickness.

Turning now to the remaining FIGS. 2-5, there are depicted embodiments of bale strapping bands in accordance with alternative embodiments of the present invention. The embodiments shown in FIGS. 2-5 employ different multiple-ply structures to accommodate differing loading and bale handling situations. Specifically, and referring to FIG. 2, there is illustrated a six-ply bale strapping band 15 in accordance with a second embodiment of the present invention. Similar to bale strapping band 10, bale strapping band 15 includes a pair of pair of folded paper strips 2 and 4 that are mutually bonded by one or more internal adhesive layers 6, and furthermore includes external adhesive layer 12 that serves a similar function as that described with reference to FIG. 1. As shown in FIG. 2, each of paper strips 2 and 4 are folded into three-ply strips with the outer lateral edge folded onto itself before being folded onto the composite band and glued thereto. The result is a six-ply composite having an outer surface coated with external adhesive layer 12 that is water-soluble and is moisture and/or heat reactivated during the strapping process.

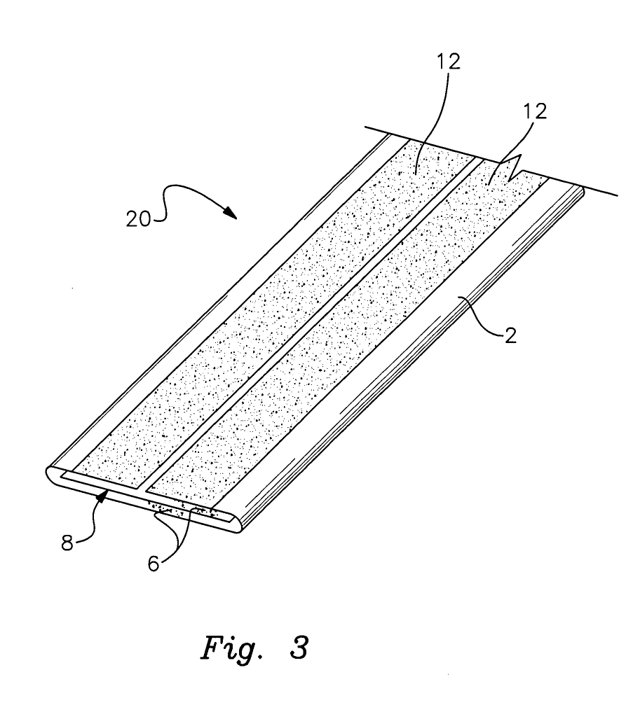

FIG. 3 depicts a bale strapping band 20 in accordance with a third embodiment of the present invention wherein the remnant edges of paper strip 2 are folded around a non-folded internal support strip 8 to form a three-ply composite. Similar to bands 10 and 15, bale strapping band 20 includes one or more internal adhesive layers 6 that adhesively bond the folded lateral sides of paper strip 2 together with internal support strip 8, which may comprise a paper or otherwise repulpable flat strip having similar or greater thickness and rigidity characteristics as the encasing paper strip 2. The substantially complete outer encasement provided by paper strip 2 acts as a sheath to protect internal support strip 8 from external cuts, or abrasions. Furthermore, bale strapping band 20 includes external adhesive layer 12 coating that is water-soluble and moisture and/or heat reactivated during the strapping process.

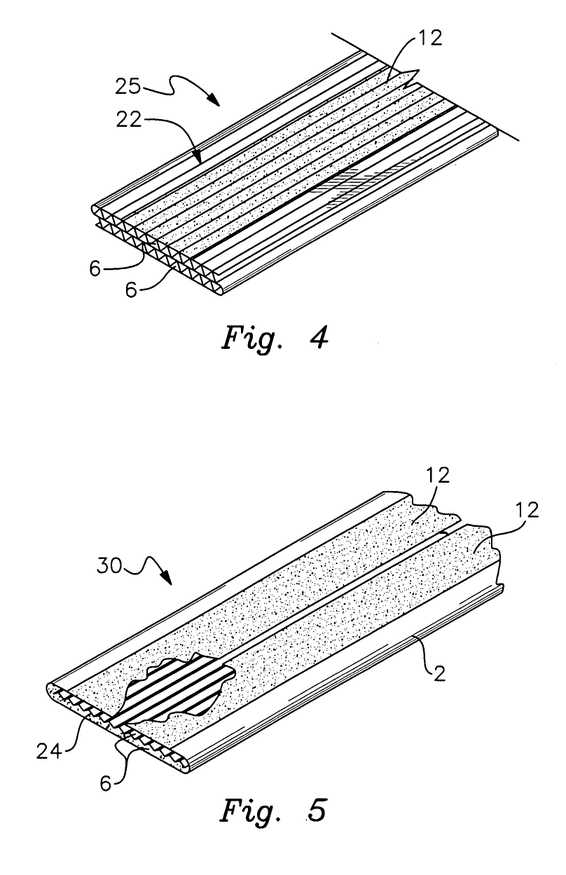

Referring to FIG. 4, there is illustrated a corrugated three-ply bale strapping band 25 in accordance with a fourth embodiment of the present invention. Bale strapping band 25 comprises a corrugated paper strip 22 that is S-folded longitudinally and which is internally bonded utilizing one or more internal adhesive layers 6. Corrugated paper strip 22 provides a surface area enhancing texture and additional structural rigidity to the composite band. Similar to the foregoing embodiments, external adhesive layer 12 having the foregoing characteristics is applied along the outer surface of bale strapping band 25.

FIG. 5 depicts an internally corrugated three-ply bale strapping band 30 in accordance with a fifth embodiment of the present invention. Bale strapping band 30 combines additional structural rigidity of a corrugated internal support paper strip 24 with the sheath-like external protection provided by paper strip 2. One or more internal adhesive layers 6 are applied within the space between internal support strip and the encasing paper strip 2. The corrugated surface of internal support strip 24 provides for enhanced rigidity of the composite strip 30. Like the foregoing embodiments, bale strapping band 30 includes external adhesive layer 12 coating that is water-soluble and moisture and/or heat reactivated during the strapping process.

The production and use of the band is accomplished by providing a plurality of paper strips, folding at least one of said paper strips longitudinally to define at least two plies, aligning and adhesively bonding said paper strips together to form a paper band having a first external surface, a second external surface and at least one internal ply, applying a water-soluble adhesive to said first and second external surfaces, said water-soluble adhesive possessing the capacity to be absorbed by said first and second external surfaces and to be reactivated after it has cured in order to subsequently bond said first and second external surfaces together, and allowing said water-soluble adhesive to cure. A paper bale is strapped by encircling the bale with the bale strapping band, reactivating a short section of the water-soluble external adhesive on the first external surface and the second external surface, pressing the first and second external surfaces together at the short section of the reactivated water-soluble external adhesive, and allowing the reactivated water-soluble external adhesive to cure. The adhesive is reactivated by applying water, heat or both.

While this invention has been described in terms of several embodiments, it is contemplated that alterations, permutations, and equivalents thereof will become apparent to one of ordinary skill in the art upon reading this specification in view of the drawings supplied herewith. It is therefore intended that the invention and any claims related thereto include all such alterations, permutations, and equivalents that are encompassed by the spirit and scope of this invention.

1. A self-adhering bale strapping band comprising:
a plurality of aligned paper strips, at least one of said paper strips being folded longitudinally to define at least two plies, said paper strips being internally adhesively bonded together;
a first external surface and a second external surface;
at least one internal ply disposed between said first external surface and said second external surface;
an external adhesive applied to said first and second external surfaces, said external adhesive adapted to be reactivated such that said first external surface bonds to said second external surface.

2. The bale strapping band of claim 1, wherein said at least one internal ply comprises multiple plies and wherein all said multiple plies and said first external surface and said second external surface are internally adhesively bonded.

3. The bale strapping band of claim 1, wherein said external adhesive comprises a water-soluble adhesive.

4. The bale strapping band of claim 1, wherein said external adhesive comprises a heat-activated adhesive.

5. The bale strapping band of claim 1, wherein said one or more paper strips comprise repulpable material.

6. The bale strapping band of claim 1, wherein said paper strips comprise a pair of paper strips each longitudinally folded into two plies such that said bale strapping band is a four-ply composite.

7. The bale strapping band of claim 1, wherein said paper strips comprise a pair of paper strips each longitudinally folded into three-ply strips such that said bale strapping band is a six-ply composite.

8. The bale strapping band of claim 1, wherein said paper strips comprise a single paper strip folded around a non-folded internal support strip such that said bale strapping band is a three-ply composite.

9. The bale strapping band of claim 8, wherein said internal support strip comprises a corrugated paper strip.

10. The bale strapping band of claim 1, wherein said paper strips comprise a single S-folded, corrugated paper strip such that said bale strapping band is a three-ply composite.

11. The bale strapping band of claim 3, wherein said water-soluble external adhesive is absorbed into said first and second external surfaces.

12. A bale strapping band for banding bales of wood pulp comprising:
one or more mutually aligned and bonded paper strips having multiple longitudinal plies including a first external ply, an opposing second external ply, and at least one internal ply disposed between the first and second external plies; and
an external adhesive layer disposed on the outer surface of at least one of said external plies such that said bale strapping band may be fixedly adhered to itself by reactivating said external adhesive layer.

13. The bale strapping band of claim 12, further comprising one or more internal adhesive layers that adheredly bind the at least one internal ply with the first and second external plies.

14. The bale strapping band of claim 12, wherein said external adhesive layer comprises a water-soluble adhesive material.

15. The bale strapping band of claim 12, wherein said external adhesive layer comprises a heat-activated adhesive material.

16. The bale strapping band of claim 12, wherein said one or more paper strips comprise repulpable material.

17. The bale strapping band of claim 12, wherein said one or more paper strips comprises a pair of paper strips each longitudinally folded into two plies such that said bale strapping band is a four-ply composite.

18. The bale strapping band of claim 12, wherein said one or more paper strips comprises a pair of paper strips each longitudinally folded into three-ply strips such that said bale strapping band is a six-ply composite.

19. The bale strapping band of claim 12, wherein said one or more paper strips comprises a single paper strip folded around a non-folded internal support strip such that said bale strapping band is a three-ply composite.

20. The bale strapping band of claim 19, wherein said internal support strip comprises a corrugated paper strip.

21. The bale strapping band of claim 12, wherein said one or more paper strips comprises a single S-folded, corrugated paper strip such that said bale strapping band is a three-ply composite.

22. The bale strapping band of claim 14, wherein said water-soluble external adhesive material is absorbed into said outer surface.

23. A bale strapping band produced by the steps of:
providing a plurality of paper strips;
folding at least one of said paper strips longitudinally to define at least two plies;
aligning and adhesively bonding said paper strips together to form a paper band having a first external surface, a second external surface and at least one internal ply;
applying a water-soluble adhesive to said first and second external surfaces, said water-soluble adhesive possessing the capacity to be absorbed by said first and second external surfaces and to be reactivated after it has cured in order to subsequently bond said first and second external surfaces together;
allowing said water-soluble adhesive to cure.

24. The bale strapping band of claim 23, further comprising the steps of:
encircling said band around a bale;
reactivating a short section of said water-soluble adhesive on said first external surface and said second external surface pressing said first and second external surfaces together at said short section of said reactivated water-soluble adhesive;
allowing said reactivated water-soluble adhesive to cure, such that said band encircles said bale.

25. The bale strapping band of claim 24, wherein said step of folding at least one of said paper strips longitudinally to define at least two plies comprises:
folding each of two paper strips longitudinally into two plies such that said bale strapping band consists of two internal plies, a first external surface and a second external surface.

26. The bale strapping band of claim 24, wherein said step of folding at least one of said paper strips longitudinally to define at least two plies comprises:
folding each of two paper strips longitudinally into three plies such that said bale strapping band consists of four internal plies, a first external surface and a second external surface.

27. A method of strapping a paper bale comprising the steps of:
providing a paper bale;
providing a bale strapping band comprising a plurality of aligned paper strips, at least one of said paper strips being folded longitudinally to define at least two plies, said paper strips being internally adhesively bonded together; a first external surface and a second external surface, at least one internal ply disposed between said first external surface and said second external surface, and a water-soluble external adhesive applied to said first and second external surfaces, said external adhesive being absorbed by said first and second external surfaces and adapted to be reactivated such that said first external surface bonds to said second external surface;
encircling said bale with said bale strapping band;
reactivating a short section of said water-soluble external adhesive on said first external surface and said second external surface;
pressing said first and second external surfaces together at said short section of said reactivated water-soluble external adhesive;
allowing said reactivated water-soluble external adhesive to cure.

28. The method of claim 27, wherein said step of reactivating said water-soluble adhesive comprises applying water.

29. The method of claim 27, wherein said step of reactivating said water-soluble adhesive comprises applying heat.
